(19) United States
(12) Patent Application Publication
(10) Pub. No.: US 2009/0319572 A1
(43) Pub. Date: Dec. 24, 2009

(54) Method and apparatus for field service management

(75) Inventor: Marc R. Bernard, Miramar, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/214,970

(22) Filed: Jun. 24, 2008

(51) Int. Cl. G06Q 10/00; G06F 17/30

(52) U.S. Cl. 707/104.1; 705/7; 705/1; 707/E17.009

(57) ABSTRACT

Installing and maintaining equipment, such as optical network terminals (ONTs), at customer sites is time consuming. At present, there is no way to manage field service to improve installation and maintenance procedures. A method or corresponding system in an example embodiment of the present invention provides aids to manage field service to make installation and maintenance procedures more efficient. In one embodiment, field technicians use a data collection device to track installation tasks and corresponding Global Navigation Satellite System (GNSS) coordinates. The collected data and coordinates are analyzed, possibly for a fee, and used to make changes in installation and maintenance procedures. As a result, service provider can save significant cost on future installations and service calls.

### BACKGROUND OF THE INVENTION

Passive optical networks (PONS) are currently used in telecommunications to provide network services to service subscribers. PONs, as used in current practice, typically include a service provider network, content server network, optical line terminal, multiplexer/demultiplexer, optical network terminals (ONTs) or units, and customer premises equipment (CPE) connected via interconnections by optical fiber. Examples of services that can be provided via such PONs include various types of telephony services, data transmission services, and video services. Signals for such services are transmitted on optical wavelengths, interchangeably referred to herein as optical carriers, from a central office or head end to an ONT at a service subscriber site. In most implementations, ONTs convert and filter optical signals from the central office into electronic signals that can be processed by customer premises equipment (CPE), such as telephones, computers, and televisions. ONTs also transduce electronic signals from CPE onto optical carriers for transmission to the central office.

Before a subscriber can receive requested services via a PON, an ONT must be installed at the subscriber site, and requested services must be activated. Typically, the service provider sends a field technician to the subscriber site to physically install an ONT, then activates a particular service subscription during or immediately following installation of the ONT. After installing the ONT, the field technician calls a service activator, who activates the subscription. In some cases, the field technician provides manual provisioning assistance at the subscriber site. For example, the field technician might read the serial number of the ONT to the service activator or operate a reset switch on the ONT upon instruction from the service activator. Activating PON services includes provisioning the requested services and associating the provisioned services with the ONT.

The installation process is time consuming. First, the field technician has to travel from a service provider warehouse to the subscriber site. Next, the field technician has to install the ONT before manually entering or calling in codes specific to the ONT to the service activator. As the number of installation steps increases, the installation time increases, and so does the probability of installation errors, factors that lead to higher installation costs. Attempts to improve installation efficiency usually focus on improving the ONTs themselves, not the installation process itself.

### SUMMARY OF THE INVENTION

A method or corresponding system in an example embodiment of the present invention provides a technique for managing field service. In example embodiments, field service technicians are equipped with devices configured to provide information about equipment being serviced during a service call. The devices are also configured to accept indicators representing information about tasks associated with the service call. Analyzing the indicators together with Global Navigation Satellite System (GNSS) coordinates of at least one of the task locations allows changing at least one of the tasks to manage efficiency of field service personnel in performing future related service calls.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram that illustrates a typical service call route and time table for a field technician installing or maintaining optical network terminals (ONTs).

FIG. 2 is a block diagram that shows a system for tracking and analyzing indicators representing service tasks.

FIGS. 3A-D are block diagrams depicting the use of an example service tracking device during the installation of an ONT in a passive optical network (PON).

FIG. 4 is a block diagram of an example service call tracking and analysis system.

FIGS. 5 and 6 are flow charts that illustrate example tracking, recording, and analysis procedures in accordance with the disclosed service call tracking tool.

FIGS. 7 and 8 are flow charts that illustrate example reporting procedures in accordance with the disclosed service call tracking tool.

FIGS. 9 and 10 are flow charts that illustrate example equipment provisioning methods in accordance with the disclosed service call tracking tool.

### DETAILED DESCRIPTION OF THE INVENTION

A description of example embodiments of the invention follows.

Example embodiments of the present invention provide a method and corresponding system of managing field service. Example embodiments include equipping field technicians with service tracking devices configured to provide information about equipment for which a service call was placed, such as model number, serial number, software/firmware version number, upgrade history, etc. In embodiments, service tracking devices also accept indications representing statuses of tasks associated with the service call, such as whether or not an upgrade is complete. The service tracking devices may also record indications of service task milestones, such as the completion of a given task, and indications of how long tasks take to carry out.

After the completion of the service call, the indications can be analyzed together with geographic coordinates related to the service call and supplied by a Global Navigation Satellite System (GNSS). A service provider can use the results of the analysis to modify service call procedures to manage efficiency of field service personnel for future service calls, which may result in improving the efficiency of the future service calls. In some embodiments, a third party stores indicators of the service task statuses and analyzes the indicators, charging the service provider for access to the analysis and the stored indicators.

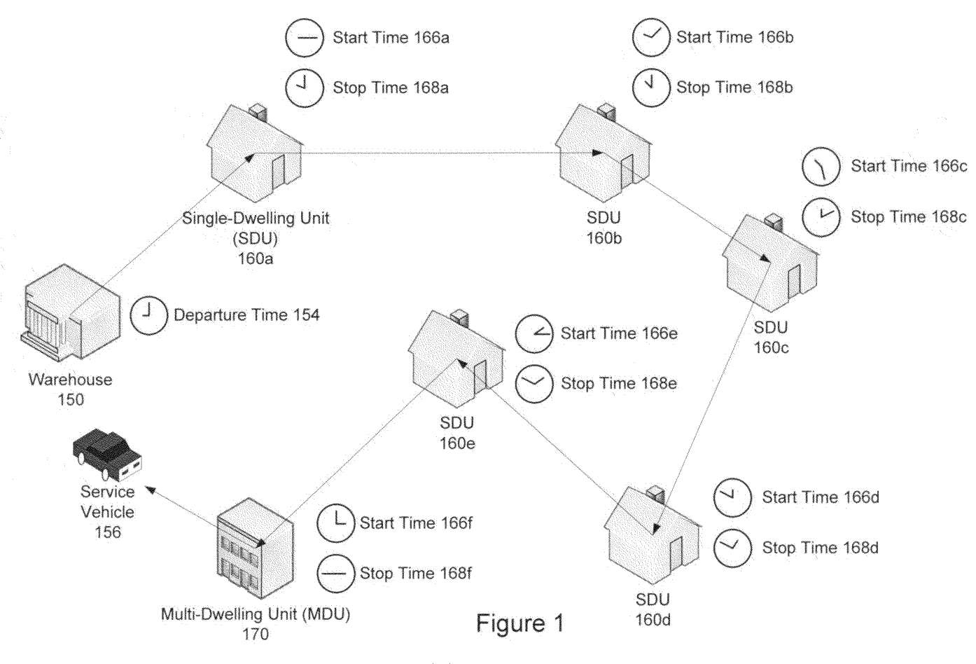

FIG. 1 is a block diagram that illustrates a route followed by a field technician executing service calls at several subscriber sites. The field technician (not shown) leaves a warehouse 150 at a departure time (e.g., 9:00 am) for the first subscriber site, in this case, a single-dwelling unit (SDU; e.g., a house) 160a. The field technician starts the service call at a start time (e.g., 9:15 am), performing at least one of a variety of service tasks. For example, the field technician may install an optical network terminal (ONT) at the SDU 160a, in which case the field technician performs the following procedure: 1) physically install the ONT; 2) validate the installed ONT; 3) register the installed ONT with an upstream network node; 4) download configuration information from the upstream network node to the ONT; and 5) perform additional tasks as needed. As part of the installation, the field technician may call a service activator to activate the subscription corresponding to the ONT. The field technician completes the installation at a stop time 168a (e.g., 10:00 am).

After completing the service call at the SDU 160a, the field technician progresses along his route, performing service calls at a variety of other subscriber sites. In the example shown in FIG. 1, the field technician visits SDUs 160b-e and multi-dwelling unit (MDU; e.g., an apartment building) 170. Start and stop times 166b-f, 168b-f characterize each service call. The time between service calls (e.g., the time between stop time 168a and start time 166b, 10:00 am to 10:10 am) is the time it takes the field technician to travel between subscriber sites. Time between service calls may also include the field technician's work breaks.

To analyze the field technician's efficiency, a service provider might measure the duration of each service call and the time between service calls. These measurements provide, at best, a gross characterization of the field technician's efficiency, as the measurements do not indicate how the field technician spent his time while on the service call. Embodiments of the disclosed field service management tool make it possible to analyze more finely the field technician's performance.

Suppose that the field technician carries a service tracking device on service calls, where the service tracking device records the start and stop times of individual tasks that the field technician performs during the service call. When the field technician installs an ONT, for example, the service tracking device may record how long it takes the field technician to: 1) physically install the ONT; 2) validate the installed ONT; 3) register the installed ONT with an upstream network node; 4) download configuration node from the upstream network node to the ONT; and 5) perform additional tasks as needed. In certain embodiments, the field technician enters task start and stop times into the service tracking device; in other embodiments, the service tracking device queries the ONT to determine task durations via a wireless or other communications link.

The service tracking device may also provide and/or track GNSS coordinates during the course of the field technician's service calls. Before the field technician leaves the warehouse 150, he may download a service call itinerary, including subscriber site addresses, to the service tracking device. The service tracking device may compute or download a service call route based on the locations of the subscriber sites, the anticipated duration of each service call, and other factors, including traffic conditions. (In general, calculating service routes is a nondeterministic polynomial-time hard, or NP-hard, problem, known as the traveling salesman problem. The service call device may compute or download a route derived exactly or heuristically, depending on the variables and the available computation time, among other things.) In addition, the service tracking device may respond to changes in the service call itinerary while the field technician is in the field. For example, the service tracking device may rearrange the itinerary, or add or drop service calls, possibly in response to instructions from a field service manager. If multiple ONTs at an apartment building fail catastrophically, depriving every resident of service, the field service manager may redirect a field technician en route to another service call to the apartment building suffering the ONT failures.

When performing service calls at apartment buildings or other MDUs, such as MDU 170 in FIG. 1, the field technician may visit one dwelling or several dwellings. In certain cases, GNSS coordinates may be unavailable or too imprecise to identify the exact location of the ONT, particularly in MDUs, where altitude usually distinguishes at least some of the dwellings. The field technician can overcome this problem by entering additional information into the service tracking device, such as the apartment number or a description of the ONT location.

In some situations, the service tracking device might lose contact with the GNSS, perhaps because of atmospheric effects or because the technician goes inside a building. The service tracking device stores its last known coordinates, then accesses a customer service database to provide the field technician with a list of possible addresses that correspond to the site of the service call. Similarly, the service tracking device can use its last known GNSS coordinates and the addresses stored in the customer service database to determine which service call to execute next.

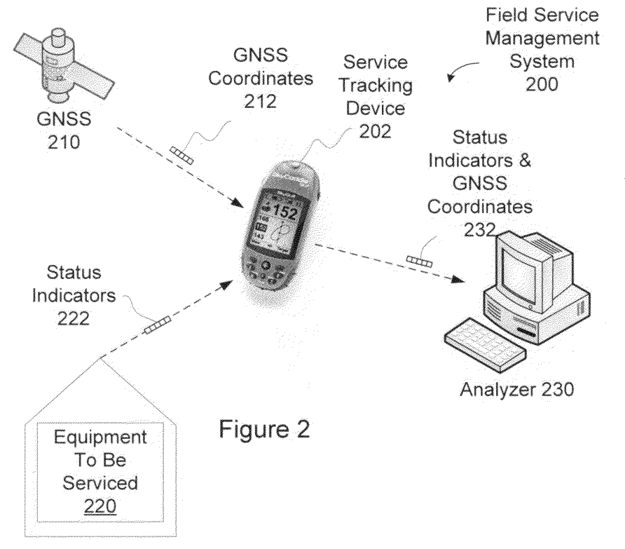

FIG. 2 is a block diagram of a field service management system 200 according to example embodiments of the principles of the disclosed service call tracking and analysis tool. Here, a field technician carries a service tracking device 202 on a service call. The service tracking device 202 receives GNSS coordinates 212 from a GNSS 210 and status indicators 222 from equipment to be serviced 220. The status indicators 222 include, but are not limited to, representations of: durations of service tasks, service task milestones, percent completion of service tasks, individually or collectively, and characterizations of the quality of service task execution (e.g., percent connection bandwidth).

The service tracking device 202 transmits or uploads status indicators and GNSS coordinates 232 to an analyzer 230. In certain embodiments, the service tracking device 202 may transmit status indicators and GNSS coordinates 232 periodically or continuously to the analyzer 230 over the course of the day via a wireless link, such as cellular, WiFi, femtocell, IEEE 802.11, infrared, or other wireless link. In other embodiments, the field technician may download status indicators and GNSS coordinates 232 from the service tracking device 202 to the analyzer 230 via a physical connection, such as a universal serial bus (USB), ethernet, plain old telephone service (POTS), or similar connection, upon returning to a warehouse or other suitable site. The service tracking device 202 may communicate with the analyzer 230 directly or through an intermediary network or node using any suitable communication means. For example, the service tracking device 202 may connect to the analyzer 230 through a WiFi network whenever the service tracking device 202 senses a WiFi connection.

Once the analyzer 230 receives the status indicators and the GNSS coordinates 232, the analyzer 230 computes statistics relevant to the efficiency of the service call. For example, the analyzer 230 may compute the actual duration of an ONT registration and compare the actual duration to an expected or desired duration, perhaps by computing a variance or standard deviation. The analyzer 230 may also collate data from the service tracking device 202 over multiple service calls to compute running averages, median task times, and so on. In addition, the analyzer 230 may compare the performance of different field technicians based on data collected by different service tracking devices 202 over multiple service calls. If different field technicians use different installation techniques, for example, performance comparisons can identify which installation technique is most efficient. The analyzer 230 can be any form of computer, processor, server, or the like configured to perform the actions described herein.

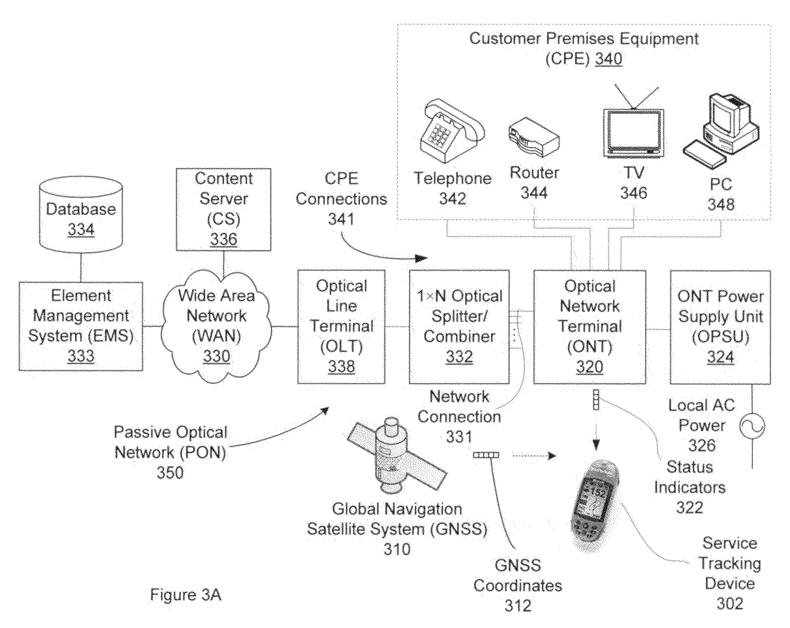

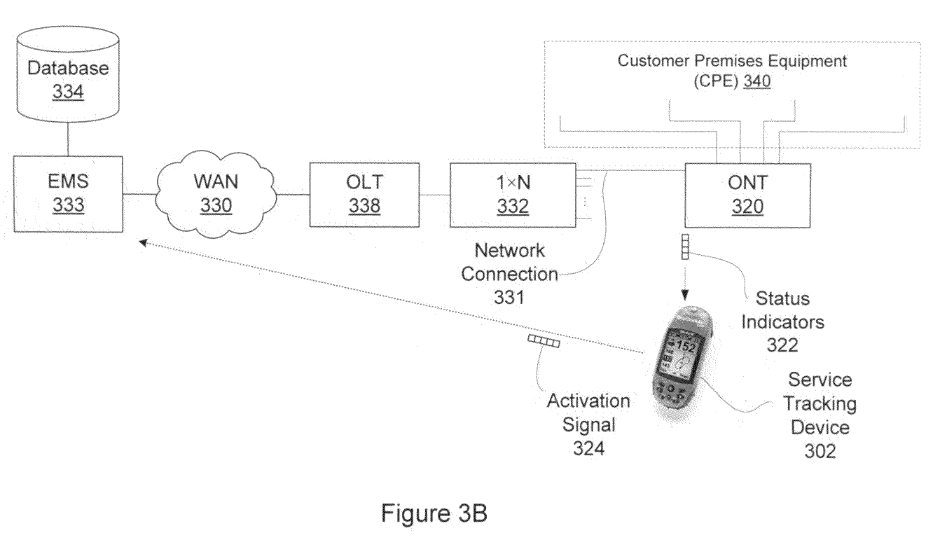

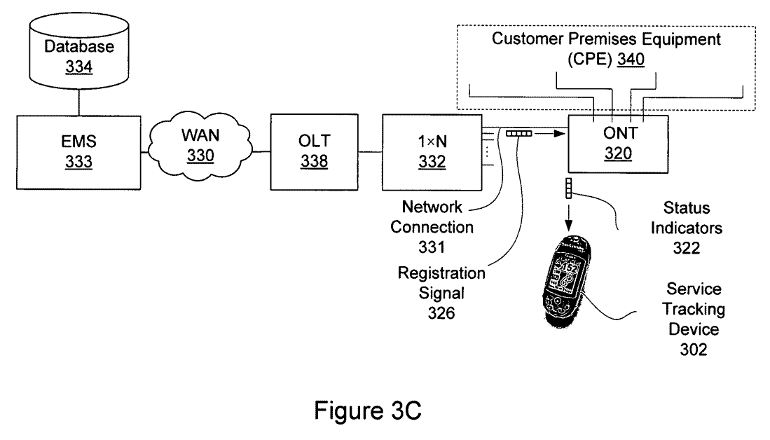

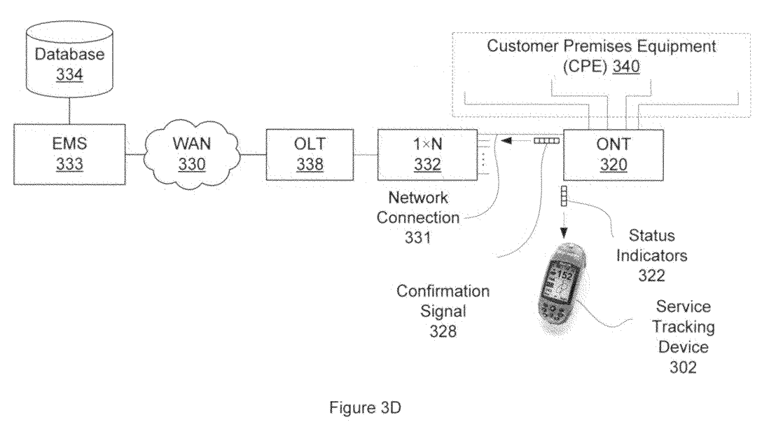

FIGS. 3A-D are block diagrams that show one way of using a service tracking device 302 to install an ONT 320 in a passive optical network (PON) 350. A field technician starts by connecting the ONT 320 to an ONT Power Supply Unit (OPSU) 324, which is powered by local alternating-current (AC) power 326 and may include a backup battery unit (BBU). The field technician may also connect the ONT 320 to a separate BBU (not shown).

To provide service to the subscriber, the field technician connects the ONT 320 to the PON 350 via a network connection 331, which, in the example shown in FIGS. 3A-D, connects the ONT 320 to a 1×N optical splitter/combiner 332. The 1×N optical splitter/combiner 332 connects, in turn, to an optical line terminal (OLT) 338, which directs upstream and downstream traffic from a wide area network (WAN) 330 to the ONT 320. Typically, the WAN 330 links multiple OLTs 338, each of which distribute signals to and from multiple ONTs 320, to an element management system (EMS) 333, at least one content server 336, and at least one database 334. Examples of the disclosed field service management tool work with any type of network, including optical networks, such as the example PON 350 shown in FIGS. 3A-D. The ONT might also connect to an optical network via a local exchange terminal instead of via an OLT.

The ONT 320 also connects to customer premises equipment (CPE) 340 via CPE connections 341. CPE 340 includes, but is not limited to, telephones 342, routers 344, TVs 346, and personal computers (PCs) 348. A single ONT 320 may connect to multiple pieces of CPE 340, where the pieces are of the same type, different types, or combinations thereof. The ONT 320 converts optically encoded signals from the WAN 330 into electronic signals suitable for use by the CPE 340; the ONT 320 also transduces electronic signals from certain types of CPE 340, such as telephones 342, routers 344, and PCs 348, into optical signals suitable for transmission over PONs 350.

In one embodiment, when the field technician powers up the ONT 320, the ONT 320 begins transmitting status indicators 322 to the service tracking device 302 over a wireless connection, such as a Bluetooth or WiFi connection. In other embodiments, the field technician physically connects the service tracking device 302 to the ONT 320, possibly using a dock or a cable, such as a USB or similar cable. The service tracking device 302 also receives and, in some embodiments, records GNSS coordinates 312 from a GNSS 310, which may be used to activate the ONT 320. For example, the service tracking device 302 may compare the current GNSS coordinates 312 to the address of the customer site. When the service tracking device 302 determines that GNSS coordinates 312 match the customer address, the service tracking device 302 may activate the ONT 320, possibly using an authentication key or similar means. Once activated, the ONT 320 can be connected to the PON 350.

Typcially, the service tracking device 302 is only configured to read data from the ONT 320. In certain cases, however, the service tracking device 302 is configured to transmit data to the ONT 320 and other components in the PON 350. In the example shown in FIGS. 3A-D, the field technician uses the service tracking device 302 to send an activation signal to the EMS 333 via a wireless (e.g., cellular) communications link instead of calling a service activator. (Of course, the service tracking device 302 may also be configured to communicate with the EMS 333 via an optical or wireline link.) Once the field technician establishes communication between the service tracking device 302 and the EMS 333, the EMS 333 sends a registration signal 326 to the ONT 320 as in FIG. 3C, pulling registration information from a database 334 and the ONT 320. For example, the EMS 333 may compare the serial number reported by the ONT 320 to a serial number stored in the database 334. The EMS 333 may also query the database 334 as to the type and level of customer subscription, e.g., broadband Internet, telephony, cable television, etc. At the same time, the ONT 320 continues to report its status to the service tracking device 302, which the service tracking device 302 records for future analysis. At the end of the registration process, the ONT 320 sends a confirmation signal 328 to the EMS 333 as shown in FIG. 3D.

The field technician may also use the service tracking device 302 to ensure that the CPE 340 is properly configured. Based on readings from the service tracking device 302, the field technician may change operating settings of the router 344 or the PC 348. Even before beginning installation, the field technician may use the service tracking device 302 to confirm that the ONT 320 being installed is compatible with the CPE 340.

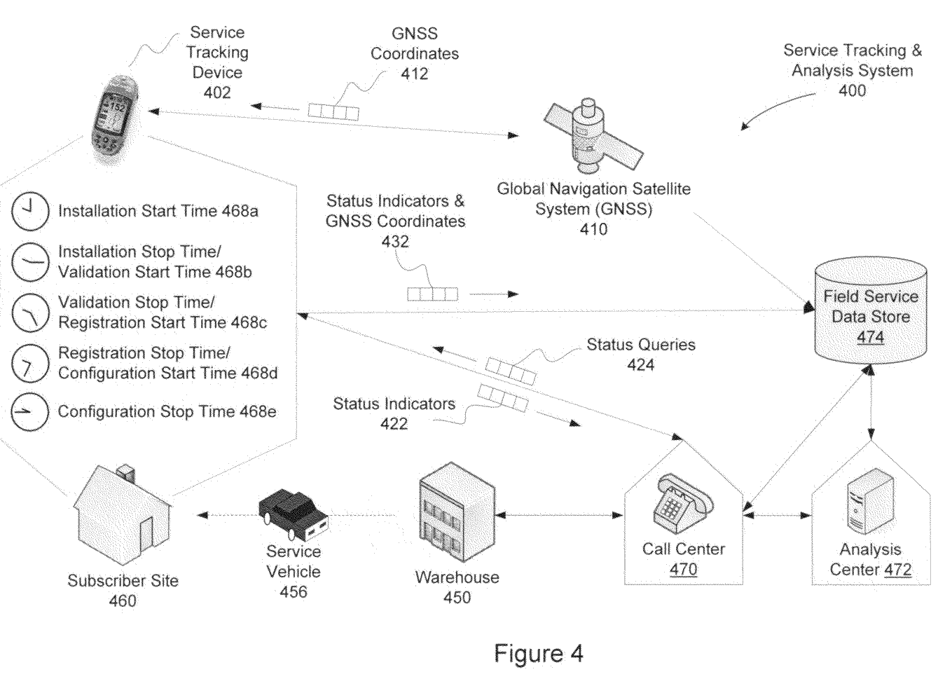

FIG. 4 is a block diagram of a service tracking and analysis system 400 according to an example embodiment of the present invention. As in FIG. 1, a field technician travels from a service provider warehouse 450 to a subscriber site 460, possibly in a service vehicle 456. When the field technician reaches the subscriber site 460, he begins installing or maintaining a piece of equipment, such as an ONT, using a service tracking device 402 to aid in both the current service call and in future service calls. The service tracking device 402 records GNSS coordinates 412 from a GNSS 410 and start and stop times 468a-e associated with various service call tasks. For example, the service tracking device 402 may record the following: installation start time 468a; installation stop time/validation start time 468b; validation stop time/registration start time 468c; registration stop time/configuration start time 468d; and configuration stop time 468e. In addition, the service tracking device 402 also records other indicators of service tasks, including indicators of task milestones (e.g., validation complete), task quality (e.g., actual connection bandwidth vs. expected connection bandwidth), and so on.

The service tracking device forwards status indicators and GNSS coordinates 432 to a field service data store 474, which collates data from the service tracking devices 402 carried by a group of field technicians. The service tracking device 402 also sends status indicators 422 to and receives status queries form a call center 470 that communicates with the field service data store 474 and an analysis center 472.

The field technician and the service provider can use the call center 470, analysis center 472, and field service data store 474 to track and analyze the efficiency of service calls. In some cases, another party, such as an equipment provider, maintains the call center 470, analysis center 472, and field service data store 474 and charges the service provider for access to data and field support. The equipment provider may use any suitable method, including subscriptions, fees for service, or combinations thereof, to bill the service provider for analysis and support related to managing service calls.

In one embodiment, the equipment provider tracks the status indicators and GNSS coordinates 432 over multiple service calls by multiple field technicians, then computes metrics pertaining to the efficiency with which the service calls are executed. For example, analysis might show a large variance in the time required to validate ONTs installed in SDUs, but not in MDUs. Further investigation could lead to changes in the installation procedure that decrease both the mean and the variance of the ONT validation time. (Decreasing variances could be especially useful, as variances in task duration make it difficult to precisely schedule service calls.) In example embodiments, the service provider makes similar changes to other installation and maintenance procedures based on recommendations from the equipment provider based on analysis of the recorded status indicators and GNSS coordinates 432.

In other embodiments, the equipment provider can use the status indicators 422 reported by the service tracking device 402 to provide support to field technicians having trouble installing or maintaining equipment. For example, consider a field technician troubleshooting an ONT experiencing intermittent transmitter failure. If the field technician has trouble diagnosing the problem (intermittent failures can be particularly difficult to trace), he can call a support technician at the call center 470. The support technician then transmits status queries 424 to the malfunctioning ONT via the service tracking device 402, the optical network to which the ONT is connected, or both. Based on the returned status indicators 422, the support technician advises the field technician as to the type of ONT malfunction and the corresponding solution. If an equipment manufacturer maintains the call center 470, the equipment manufacturer can charge the service provider for support calls to the service center.

The network provider and the service provider can also use the service tracking device to facilitate upgrades and maintenance. To upgrade installed equipment, for example, the field technician downloads software or firmware from the service tracking device 402 to the ONT being upgraded. In addition, the service provider or the equipment provider may distribute service notes or manuals via the service tracking device 402 to the field technicians as needed, including in response to GNSS coordinates 412, status indicators 422, or status queries 424 received by the service tracking device 402.

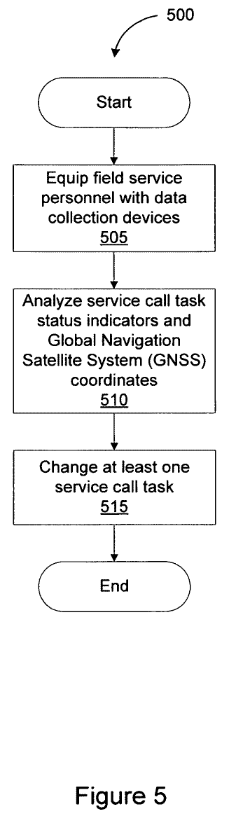

FIG. 5 is a flow diagram that shows an example procedure 500 of the disclosed field service management tool. In the procedure 500, field technicians are equipped with data collection devices for monitoring statuses of tasks performed on service calls (505). The data collection devices may be configured to track GNSS coordinates and to record indicators of service task milestones and durations. The field technicians compile indicators of the service call tasks and GNSS coordinates into service call logs, which are then analyzed (510) to give indications of the efficiency with which the service call was executed. Based on the analysis, changes can be made to service call procedures and tasks to improve the efficiency of the service call execution. The analysis may also reveal that certain software has grown stale, prompting a service or equipment provider to upgrade, replace, or remove the software or associated component.

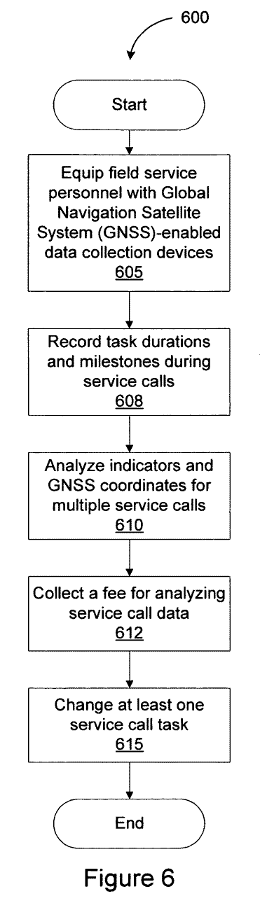

FIG. 6 is a flow diagram that shows an alternative procedure 600 of the disclosed field service management tool. Like the procedure 500 (FIG. 5), the procedure 600 of FIG. 6 begins with distributing GNSS-enabled data collection devices to field technicians who install and maintain equipment, such as ONTs (605). The data collection device records indicators of the service call, such as task durations and task milestones, which represent the completion of given service tasks (608). The recorded indicators and GNSS coordinates for multiple service calls are analyzed for information relating to the efficiency of the service call (610); in the embodiment of FIG. 6, this analysis is carried out in return for a fee (612). Changes to at least one of the service tasks (615) result from the analysis (612).

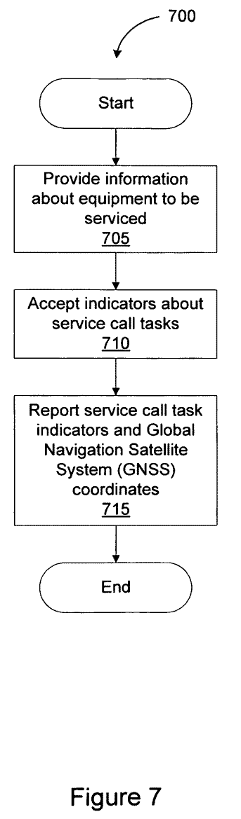

FIG. 7 is a flow diagram that shows a procedure 700 of aiding in field service according to principles of the disclosed invention. 705 provides information about the equipment to be serviced, including GNSS coordinates. In embodiments, the information may be provided to a field technician via a service tracking or data collection device, such as those depicted in FIGS. 2-4. The service tracking device accepts indicators about service call tasks (710) and reports the indicators and the GNSS coordinates of the service call (715).

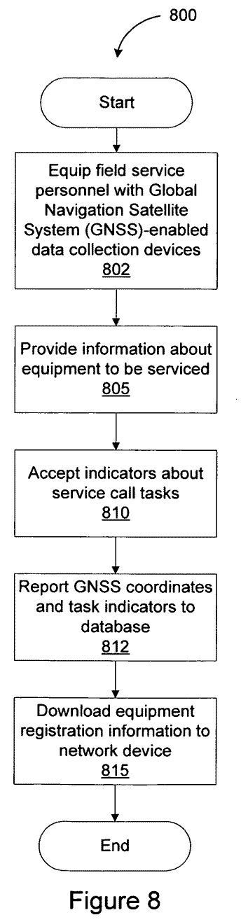

FIG. 8 is a flow diagram that shows a procedure 800 of aiding in field service according to an example embodiment of the disclosed invention. The procedure 800 begins with equipping field technicians with GNSS-enabled data collection devices (802). In 805, the field technicians are provided with information about the equipment to be serviced, including, but not limited to, the following: GNSS coordinates, customer request, scheduled service task, required parts, service call procedure, and anticipated service call duration. The data collection device may also use the GNSS coordinates to provide the field technician with directions to the customer site. The data collection device accepts indicators about the service call tasks, either from the field technician, the equipment being serviced, or both, over the course of the service call (810).

During or after the service call, the data collection device reports the indicators and the GNSS coordinates to a database, EMS, or management server, any of which may decode the GNSS coordinates (812). Reported data may be used in analyses of the service calls and to reconstruct the location of the customer equipment if GNSS service is interrupted. The data collection device also downloads registration information to the ONT, which transmits the registration information to the database, EMS, or management server, enabling the ONT to range itself on the PON.

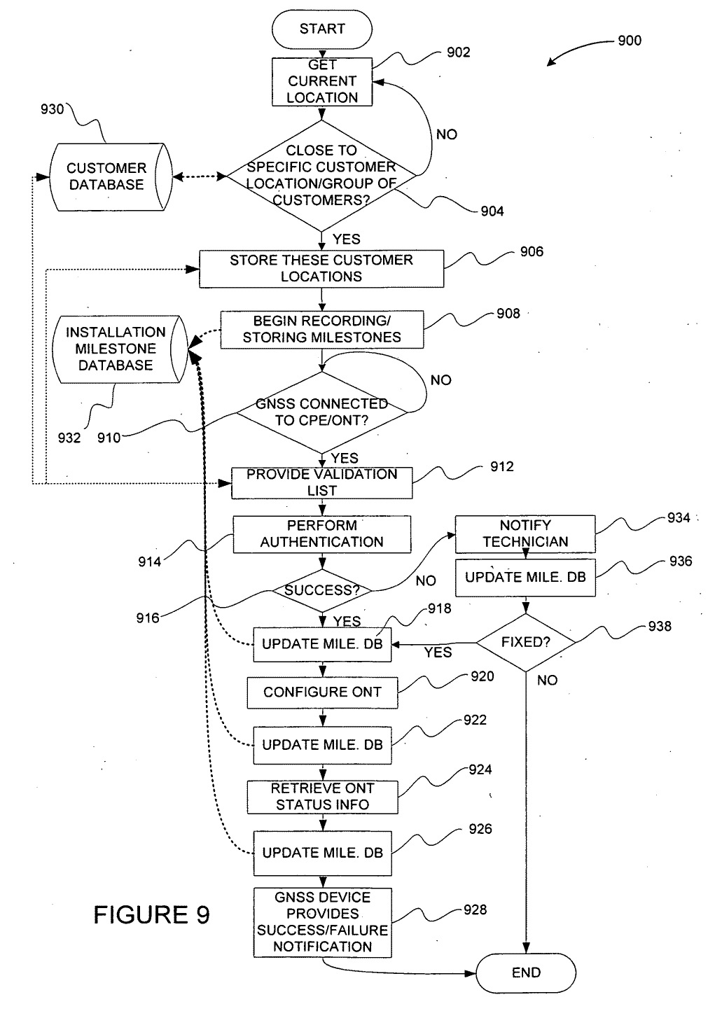

FIG. 9 is a flow chart that illustrates yet another procedure 900 for managing field service using a GNSS-enabled service tracking device, such as those shown in FIGS. 2-4. First, the field technician uses the service tracking device to determine a current location based on GNSS coordinates (902). The service tracking device compares the current location to the location(s) of the customer site(s) (904), which are stored in a customer-service database 930. If the service tracking device is close enough to a customer site or group of customer sites, it stores the customer location (906); otherwise, the service tracking device continues to query its GNSS coordinates. Location comparison and storage may be automatic or user-driven.

Once the field technician arrives at the customer site and begins installing the ONT, the service tracking device begins recording and storing indications of installation milestones (908), including times and actions about specific tasks, in an installation milestone database 932. In the course of installing the ONT, the field technician connects the service tracking device to the ONT (or possibly to CPE) at the customer site (910). This connection may be a physical connection (e.g., a cable) or a wireless connection (e.g., a Bluetooth link).

Once the service tracking device is connected to the ONT, the field technician retrieves validation information for the customer site in question from the customer service database 930 (912). The field technician authenticates the ONT (914) and verifies the authentication (916); if the authentication succeeds, the service tracking device updates the milestone database 932 (918), then continues on with the installation. Other installation operations include: configuring the ONT with the customer registration identification (920); updating the milestone database 932 (922); retrieving ONT status information, ranging time, download time, etc. (924); updating the milestone database 932 with ranging and validation information (926); and indicating a service-call quality rating based on the communications provided to the customer (928). For example, the rating might indicate total success, partial success, or failure based on the achieved connection bandwidth.

If authentication fails in 914 and 916, the service tracking device may notify the field technician (934) and store an indication of authentication failure in the milestone database 932 (936). If the field technician fixes the problem and successfully authenticates the ONT (938), the installation continues from 918. Otherwise, the installation ends, leaving the field technician to cancel or reschedule the installation.

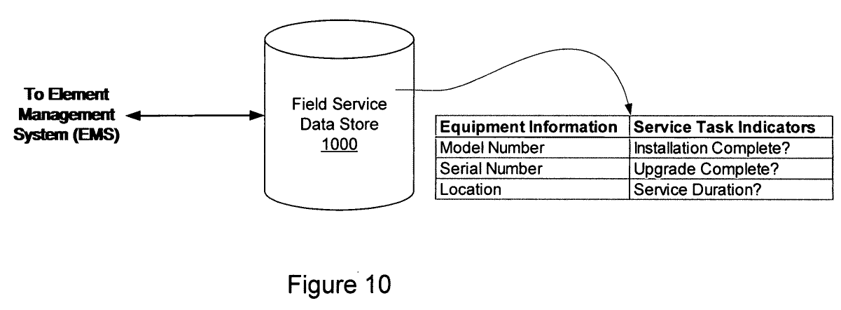

FIG. 10 is a block diagram that shows a database 1000 in yet another embodiment of the disclosed field service assistance tool. The database 1000 may include information about ONTs or CPE for which a service order was placed, including the GNSS coordinates of a location of the equipment and information based on analysis of indicators representing status of tasks associated with the service order.

The examples presented herein can include more or fewer components, be partitioned into subunits, or be implemented in different combinations. Moreover, the flow diagrams of FIGS. 3-8 may be implemented in hardware, firmware, or software. If implemented in software, the software may be written in any software language suitable for use in optical networks. The software may be embodied on any form of computer readable medium, such Random Access Memory (RAM), Read-Only Memory (ROM), flash memory, or magnetic or optical disk, and loaded and executed by generic or custom processor(s). The software may be transported and applied to the devices and equipment described herein via any form of network link, including wired, wireless, or optical links, and via any form of communications protocol.

While this invention has been particularly shown and described with references to example embodiments thereof, it will be understood by those skilled in the art that various changes in form and details may be made therein without departing from the scope of the invention encompassed by the appended claims.

What is claimed is:

1. A method of managing field service, comprising:
equipping field service personnel with a device configured to provide information about equipment for which a service call was placed and to accept indicators representing information about tasks associated with the service call;
analyzing the indicators in combination with at least one Global Navigation Satellite System (GNSS) coordinate of where at least one of the tasks was performed; and
changing at least one of the tasks based on the analyzing to manage efficiency of the field service personnel in performing future related service calls.

2. The method according to claim 1 wherein equipping field service personnel with a device configured to provide information about equipment includes equipping the field service personnel with a GNSS-enabled device.

3. The method according to claim 2 wherein the GNSS-enabled device is external from a Passive Optical Network (PON) or service-supporting PON element.

4. The method according to claim 1 wherein equipping field service personnel with a device configured to provide information about equipment includes training the field service personnel to cause the device to accept the indicators upon reaching respective milestones representing task completions.

5. The method according to claim 1 wherein the indicators representing information about of tasks include at least one of the following: duration of travel between a service provider warehouse and a service order location associated with the service call, duration between arriving at the service order location associated with the service call and installing the equipment, duration to validate the installed equipment, duration to register the installed equipment with an upstream network node, duration for the upstream network node to download configuration information to the installed equipment, duration for the field service personnel to complete any additional installation tasks associated with the installed equipment and return to a field service personnel vehicle, and duration of travel between the service order location and another service order location.

6. The method according to claim 1 wherein the service call includes installing the equipment, troubleshooting the equipment, or a combination thereof.

7. The method according to claim 6 wherein the service call further includes providing registration information about the equipment that allows the equipment to range.

8. The method according to claim 1 wherein analyzing the indicators includes analyzing the indicators in combination with at least one GNSS coordinate over multiple related service calls.

9. The method according to claim 1 further including collecting a fee for granting access to indicators representing the at least one of the tasks.

10. The method according to claim 1 further including collecting a fee for analyzing the indicators.

11. The method according to claim 1 further including collecting a fee for results of the analyzing the indicators.

12. The method according to claim 1 further including collecting a fee for troubleshooting support based on the at least one of the tasks.

13. The method according to claim 1 further including collecting a fee for providing service validation to a third-party equipment manufacturer, the third-party equipment manufacturer engaged in selling equipment and service validation to a service provider.

14. The method according to claim 1 further including collecting a fee from a service contract that includes software updates to remedy a problem detected by changing the at least one of the tasks.

15. A system to manage field service, comprising:
a device configured to provide information about equipment for which a service call was placed and to accept indicators representing information about tasks associated with the service call; and
an analyzer configured to analyze the indicators, in combination with at least one GNSS coordinate of where at least one of the tasks was performed over multiple related service calls, and configured to provide feedback to enable a service provider to consider a change of at least one of the tasks based on the analyzing to improve efficiency of the field service personnel in performing future related service calls.

16. The system of claim 15 wherein the device is a GNSS-enabled device.

17. The system of claim 15 wherein the device is further configured to accept indicators of milestones, where a milestone represents completion of a service task.

18. The system of claim 17 wherein the indicators representing information about tasks include at least one of the following: duration of travel between a service provider warehouse to a service order location associated with the service call, duration between arriving at the service order location associated with the service call and installing the equipment to a local network node, duration to validate the installed equipment to the local network node, duration to register the local network node with an upstream network node, duration for the upstream network node to download configuration information to the local network node, duration for the field service personnel to complete the installed equipment to the local network node and return to a field service personnel vehicle, and duration of travel between the service order location and another service order location.

19. The system of claim 15 further including an account database configured to track a fee for providing information about the equipment for which the service call was placed.

20. The system of claim 15 wherein the service call includes a request for installation of the equipment, troubleshooting of the equipment, or a combination thereof.

21. The system of claim 15 wherein the device is external from a PON or service-supporting PON element configured to manage field service.

22. A method to aid in field service, comprising:
providing information about equipment for which a service order was placed, at least a portion of the information being a function of GNSS coordinates of a location of the equipment;
accepting indicators representing statuses of tasks associated with the service order; and
reporting the GNSS coordinates and indicators to aid in field service.

23. The method according to claim 22 further including providing field service personnel with a GNSS-enabled device to aid in the field service.

24. The method according to claim 22 wherein the at least the portion of the information includes a last known GNSS coordinate of the location of the equipment in case GNSS signaling is interrupted during fulfillment of the service order.

25. The method according to claim 22 wherein reporting the GNSS coordinates and indicators includes reporting to GNSS-enabled equipment, a central management server, or a combination thereof.

26. The method according to claim 22 wherein the equipment is an Optical Network Terminal (ONT) and wherein the method further includes transmitting registration information to the equipment to allow the equipment to range.

27. A database to assist field service, comprising:
information about equipment for which a service order was placed, at least a portion of the information being a function of GNSS coordinates of a location of the equipment; and
resultant information based on analysis of indicators representing information about tasks associated with the service order.

28. The database of claim 27 wherein the information about the equipment includes at least one of the following on a per equipment basis: customer premises address, equipment serial number, equipment registration code, or any combination thereof.

29. The database of claim 27 wherein the equipment is an ONT.

30. The database of claim 27 wherein the indicators representing information about tasks includes at least one of the following: duration of travel between a service provider warehouse to a service order location associated with the service order, duration between arriving at the service order location associated with the service order and installing the equipment to a local network node, duration to validate the installed equipment to the local network node, duration to register the local network node with an upstream network node, duration for the upstream network node to download configuration information to the local network node, duration for the field service personnel to complete the installed equipment to the local network node and return to a field service personnel vehicle, and duration of travel between the service order location and another service order location.
